(19) United States
(12) Patent Application Publication
(10) Pub. No.: US 2014/0121798 A1
(43) Pub. Date: May 1, 2014

(54) BIODIESEL DIDACTIC PLANT AND INDUSTRY SIMULATION

(71) Applicant: Biominal Engenharia e Industria de Energia Ltda, Itauna-MG (BR)

(72) Inventor: Alex Nogueira Brasil, Itauna - MG (BR)

(73) Assignee: BIOMINAL ENGENHARIA E INDÚSTRIA DE ENERGIA LTDA, Itauna–MG, BR (BR)

(21) Appl. No.: 13/637,677

(22) PCT Filed: Jul. 15, 2011
(86) PCT No.: PCT/BR11/00237

§ 371 Date: Sep. 27, 2012

(51) Int. Cl. G05B 17/00

(52) U.S. Cl. CPC G05B 17/00
USPC 700/97

(57) ABSTRACT

It refers to a system and method for producing biodiesel in a didactic way and in small amount, providing a reactional and processing system which simulates the conditions and existing characteristics in industrial processes of biodiesel production, allowing the study, knowledge and control of important process variables. For it has transparent tanks in borosilicate-type glass, it allows the follow-up in a didactic way of all steps of the process and, considering the small amount processed, it provides an economy in the use and consumption of reagents and supplies, in addition to being easily transported and allocated in reduced spaces.

The present invention belongs to the field of equipment for producing biodiesel from vegetable oils or animal fats in natura and residual such as soybean oil, jatropha, crambe, sunflower, colza, cotton, among others.

The development and use of a didactic module for producing biodiesel are inserted in a targeted effort to improve the teaching of subjects in the area of renewable energies given in undergraduate and postgraduate studies of Brazilian universities, in aiding the development of research related to biofuel liquids and as a tool to adjust the industrial processes of production of biodiesel. The perceived importance of the experimental study, particularly for biofuels, in undergraduate and postgraduate studies is reinforced over the current context in terms of energy generation and efficient use.

The present invention provides a reaction and processing system that simulates the conditions and existing characteristics in biodiesel industrial processes and, allows the study, knowledge and control of important process variables. By working in smaller scales, it enables saving in the use and consumption of reagents and supplies as well as being easily allocated and transported in small spaces.

The didactic characteristic and possibility of simulation of industrial processes for production of biodiesel are the main innovative parameters depending on the state of the technique worldwide, combined with the versatility and flexibility in terms of possibility of variation of all process parameters such as: vegetable oil, alcohol, catalyst, temperature and time of reaction and distillation. On the issue of innovation, the construction of glass-type reservoirs in transparent borosilicate, which allows visual monitoring of all process steps, and the use stainless steel for construction the other equipment of other polymeric material resistant to biodiesel for sealing are highlighted.

Another innovative feature is related to the small volume processed, up to six liters per batch, which provides an economy in the use and consumption of reagents and supplies as well as being allocated and transported easily in small spaces. Also, it uses the dry process of purification (“Dry Wash”) through polymeric resin of ionic exchange, without generation of waste wash water, so problematic in the conventional processes of biodiesel producing.

### STATE OF THE TECHNIQUE

There are several works about biodiesel production. Processes of different routes are described, typically using batch processes and eventually semi-continuous processes with the insertion of expensive technologies and of difficult operation, such as the microwave or ultrasound energy.

An example of this is the patent application U.S. 2004/0074760 A1, which describes a reaction route in which the catalyst is mixed with oil and microwave energy is applied to force the mixture after the addition of the alcohol source. It is said that the process is not only capable of producing biodiesel, as well as products of fractionated distillation, such as gasoline and kerosene.

Today in Brazil, there are some companies that own technology to build biodiesel plants with high added technology, as patents PI 0603386-5 A, PI 0703023-1 A2 and UM 8602286-5 U, selling plants with high production capacity, from 1000 liters/day, with selling prices over US $350,000.00 (three hundred fifty thousand dollars), which makes it the purchase of such equipment impractical to small farmers, settlements and academic research groups.

The Brazilian application PI 0404243-3 A protects a process of producing biodiesel from semi-refined vegetable oil, anhydrous alcohol and alkaline catalyst in heated reaction medium/system which occurs in two stages. Both occur at temperatures between 60-80° C. when, after the first stage, the products are sent to a heating stage for the recovering of the unreacted alcohol through evaporation followed by condensation of the same. As soon as the liquid mixture is cooled and separated into two phases, the lighter a mixture of esters and oil and the most dense a phase which is rich in glycerin. Then the light phase is directed to the second reactor, where more alcohol is added in accordance with the need for continuity of the reaction to achieve a desired transformation. The catalyst is neutralized with an acid additive, the eventual excess of alcohol is recovered and the phases, the reaction products, separated by decantation or centrifugation. The phase of interest, the light one, is washed with the water mixture and then strongly heated to remove water incorporated into the organic phase.

It is noteworthy that the process described above has technical flaws regarding the thermodynamics of the reaction in question, due to the steps described of after-treatment of the reaction mixture, and besides, due to the procedures used, it could compromise the economic viability of it and moreover, have an excessive dependence on external supplies of the production route.

The Brazilian work patented under the number PI 0503631-3 describes a process for producing biodiesel, especially from castor oil, but also applicable to other oil sources, whose catalytic process, acid or basic, occurs in two phases, the first in two reactor vessels in parallel. After the phases are separated, light and the more dense one, the first is directed to a second reactor, where the lines of the first two tanks are mixed, for a second reaction step. The afore-mentioned process also emphasizes the reuse of a part of the catalyst available in the glycerin; it refers to the most dense part, as cited above, to reduce the emission of waste. Another point to be noted concerns the recovery of the alcohol, which must be added to the reaction in excess so that it occurs more quickly and efficiently. This recovery stage is performed after the separation of the phases and washing process of the fuel produced, as a purification step.

Such work comes with the idea, even though tasteless, of reuse of one of its process lines in a following stage to make use of the exceeding catalyst in a second stage of reaction, however, such action could significantly affect the reaction kinetics considering the incorporation of a reaction product as a vehicle for a supply. On the other hand it initiates with the idea of not mixing the dense phase, reaction product, with washing water, exactly so as not to compromise its employment later. Such an organization has proved to be interesting and safe in future procedural routes, tested by this group and one of the key reasons of the distinction of this work.

Another recent work, The PI 0700781-7, concerns the production of biodiesel from animal fat, particularly swine fat, using methanol as a source of alcohol. However it proves to be an inefficient process regarding the final assured quality of the product as well as the time of the process as a whole. In contrast, the process of interest of this work, does not apply to the conversion of animal fat into biodiesel, the focus here intended can only be applied if that fat is mixed, under heating, with a vegetable oil.

Well described by recent work registered under the code PI 0604251-1, the vegetable oils, when extracted, either by the use of organic solvents or compression, bring in their composition, not just the triacylglycerides, but also some level organic acidity, due to the presence of free fatty acids. Other possible components of these oils are substances commonly referred to as “non-saponifiable matter.” Intuitively one can see that these compounds are not transformed into biodiesel when transesterification reaction occurs, as soon as the removal of this fraction is made necessary, in order to raise the purity of the final product, biodiesel. A process called degumming is applied, for example. However, some of these components should be kept in the oil, even without being transformed, yet they give some interesting features both to the oil and fuel, such as stability to oxidation, as is the case of tocopherols and sterols. Unfortunately, in withdrawing one of the unsaponifiable components, withdraw all the others. This work does not address, however, the employment of the solid part, inherent product of the step of extracting oil from oilseeds and that, in addition, the present inventive process explores a potential direct application in a step purification of biodiesel, product of main interest.

### DESCRIPTION OF THE INVENTION

In view of the exposed technique and existing fundaments, the subject of this application is the development of a biodiesel plant on a small scale, with emphasis on the characteristics of teaching and industrial simulation, which allows the simulation of the existing conditions and characteristics in industrial processes of biodiesel production, enabling the study, knowledge and control of all process variables. Mobility, versatility and ease of use were primary factors for the development of the project.

The Biodiesel Didactic Plant and Industrial Simulation followed the philosophy of putting low cost equipment to use, easy to use and transport. With a production capacity of up to six liters of biodiesel per batch, its small dimensions allow its installation in biofuels production and analysis laboratories.

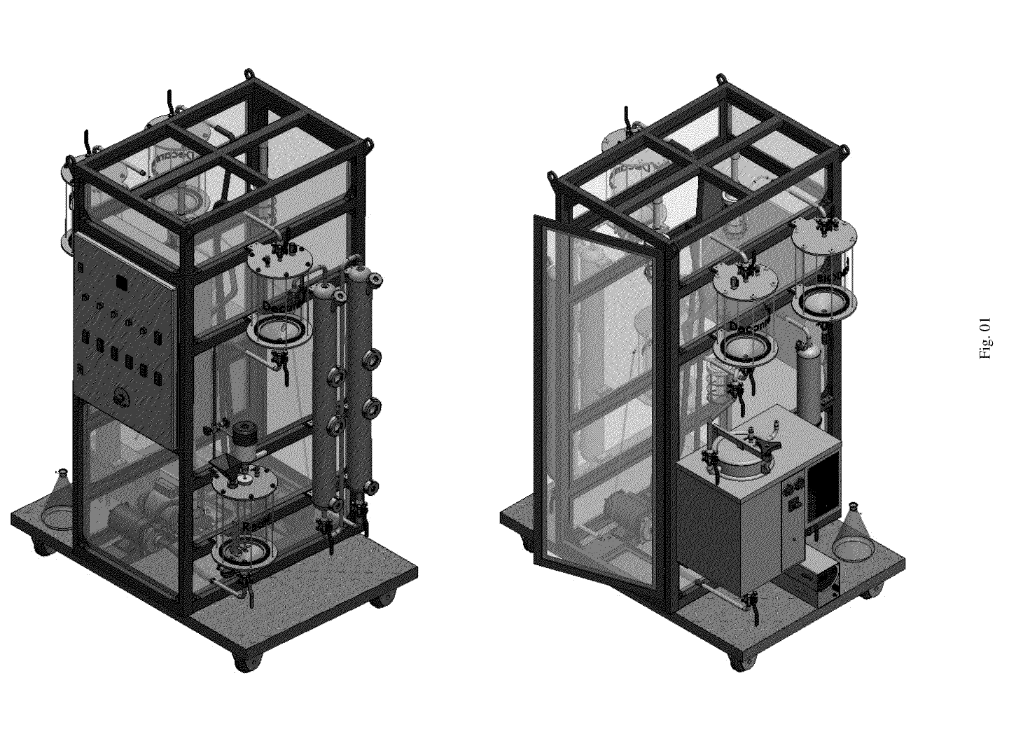

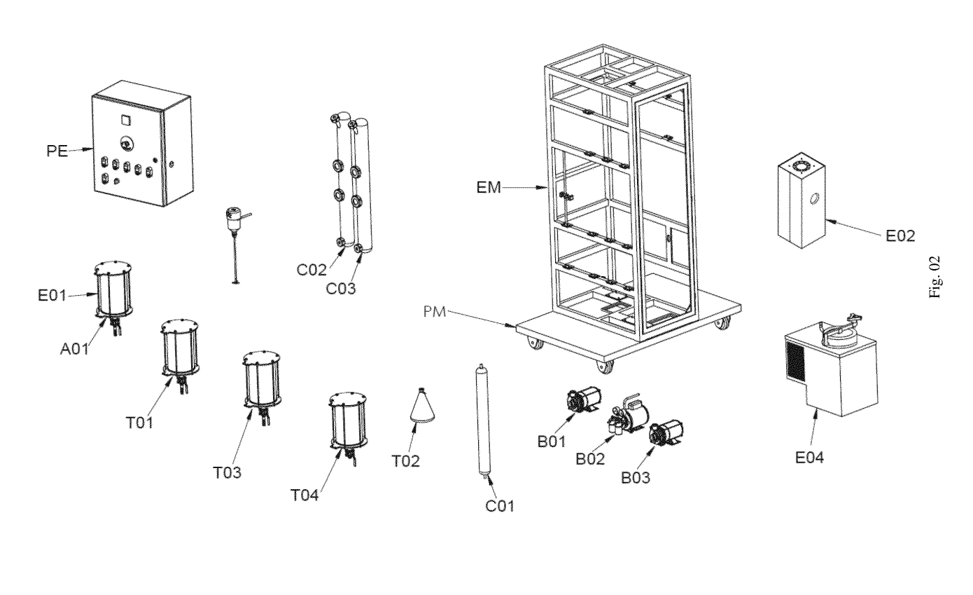

The Biodiesel Didactic Plant and Industrial Simulation, FIGS. 01 and 02, is designed to work with any type of oils/oilseeds including those obtained from the processes of cooking food. In this specific case we have the initial proposal to work with the following oleaginous seeds/plants: soybean, sunflower, jatropha, crambe and their mixtures. The ethyl and methyl alcohols are used as reagents in the process, being the ethanol a priority for it comes from renewable sources and because Brazil has a large availability of this raw material. As catalysts, it has been the proposal to work with NaOH and sodium methylate (30%) as it is already being used in the bench synthesis, which does not preventing other catalysts to be used.

In the project of the Biodiesel Didactic Plant and Industrial Simulation several factors associated directly with the technical and economical part of the process for producing biodiesel were considered. Research of the compatibility of materials used in pipes, fittings, slide valves and in the making of the tanks was conducted.

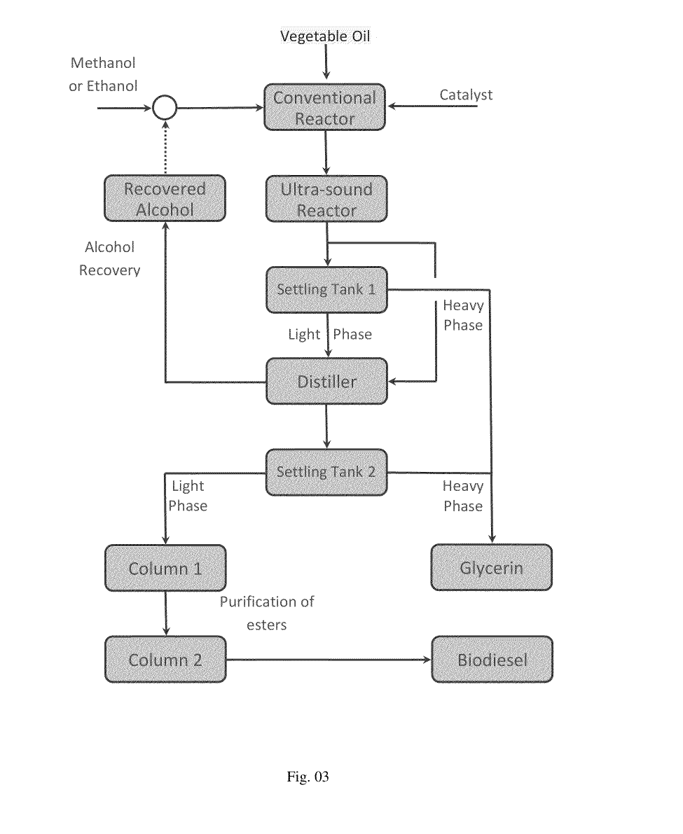

FIG. 03 shows the process flowchart for the model in reduced scale, identifying its various devices and tanks. The didactic module and industry simulation in question was designed and built with the need for a versatile device that could be used in conventional classrooms as basic parameter.

According to FIGS. 01 and 02, respectively, technical drawing and exploded view of the Biodiesel Didactic Plant and Industrial Simulation, the plant was designed and built on a modular structure over a mobile platform equipped with casters. On such structure the equipment and utilities were built and organized, namely:

first reactor (E01) with heating (A01) and temperature control between room temperature and 90° C., in addition to stirring with a naval propeller pushed by engine with spin control. Made into cylindrical frame of borosilicate-type glass of high resistance, with support flanges in stainless steel 304 and Viton® sealing;

second reactor (E02) by irradiation by ultra-sound and control system of parameters of the reaction;

first decanter (T01), with cylindrical frame of borosilicate-type glass of high resistance, with support flanges in stainless steel 304 and Viton® sealing. It has flow control valves to adjust the injection of compressed air. Feeding of the reaction mixture through the top part and two outputs, controlled by tripartite sphere manual valve (stainless steel 304), a lower one for removal of heavy phase (glycerin) and another side one, for conducting the biodiesel in processing to the next stage of distillation;

Distiller (E03) with thermal/heat oil heating system, jacketed, with temperature control and time set by PLC. Feeding of the reaction mixture through the top side part and two outputs/exists, controlled by tripartite sphere manual valve (stainless steel 304). Bottom output/exist to conduct biodiesel to the next stage of purification and the upper one to remove the recovered alcohol. Coupled to this, a vacuum pump to remove alcohol vapor from the atmosphere of evaporation;

heat exchanger (E04) made with copper pipes and aluminum plates, is designed to eliminate heat from the alcohol vapor coming from the distiller;

alcohol tank (T02), “Kitasato flask” in borosilicate-type glass with upper side part output for coupling the vacuum pump and top input/slot for directing the alcohol recovered from the distiller;

second decanter (T03), with cylindrical frame of borosilicate-type glass of high resistance, with support flanges in stainless steel 304 and Viton® sealing. It has flow control valves to adjust the injection of compressed air. Feeding of the reaction mixture through the top part and two outputs/exists, controlled by tripartite sphere manual valve (stainless steel 304), a lower one for removal of the heavy phase (glycerin) and another side one, for conducting the biodiesel in processing to the next stage of purification;

steering column (C01), in stainless steel 304 tube to store the glycerin produced and separated in the process, which can be directed to the primary purification in the distiller, fed through the top part and depletion through the bottom, controlled by tripartite sphere manual valve (stainless steel 304);

02 columns of dry polishing (C02 and C03) in 304 stainless steel tube with windows properly positioned to monitor the purification and saturation process of the resin contained therein. With access at the top and bottom for feeding and removal of the resin of ion exchange. Feeding through the top part with nylon tube linked by “quick coupler” connector, output at the bottom, driven by flow control valve. The flow of crude ester in the columns is constant and the flow forwarded by compressed air supplied by compressor blades;

biodiesel tank (T04), with cylindrical frame of borosilicate-type glass of high resistance, with support flanges in stainless steel 304 and Viton® sealing. Feeding of the purified biodiesel at the top and a bottom output, controlled by tripartite sphere manual valve (stainless steel 304) for removal of biodiesel after the purification stage;

electric panel (EP) with central control for activating pumps, engines, equipment and compressed air flow system;

modular structure (MS), made of carbon steel for attachment of tanks and equipment of the Biodiesel Didactic Plant and Industrial Simulation;

mobile platform (MP) with independent wheels, allows the movement and displacement of the Biodiesel Didactic Plant and Industrial Simulation.

The reactor and tanks are made of cylindrical frame of borosilicate-type glass of high resistance, with support flanges in stainless steel 304 and Viton® sealing and apparent tubing in stainless steel of the same type. The total weight of systems and equipment is approximately 300 kg, with dimensions of 1500 mm in length×1000 mm in width×2100 mm in height.

The biodiesel production process, represented in FIG. 03: Flowchart of the “Didactic Process and Industrial Simulation of Biodiesel Production,” designed and built on a modular structure.

The process of biodiesel production occurs as follows: vegetable oil eventually pre-prepared is added in the first reactor (E01) under heating (A01), alcohol is added and strong agitation is carried out to force the mixture of the two phases. Once the catalyst is added and, mechanical stirring and temperature control, the reaction develops. This mixture can stay long enough for the reaction to occur completely, between 60 and 120 minutes, or it can be forwarded to the second reactor (E02) for the conversion into ester minimum of 96.5% to be achieved by irradiation by ultra-sound.

After supplies react, there is biodiesel and glycerin, these will separate before or after the distillation step (E03). Due to the considerable difference in density, the process can be accomplished by decanting (T01 or T02), with the aid of gravity, aiming at saving energy and space.

Through pumping (B01), the reacted mixture is then directed to the first decanter or to the distiller (E03) according to the process and type of alcohol adopted. Once the mixture with the exceeding alcohol comes to the distiller (E03), a thermal/heat oil heating system is activated for evaporation of the alcohol added in excess in the reaction step, to increase efficiency and kinetics of the reaction. Vacuum is added to the system using a pump (B02) in order to remove the oxygen from the distiller (E03) and reduce the boiling temperature of the alcohol, thus avoiding oxidation and consequent degradation of biodiesel.

The exceeding alcohol evaporated in the distiller (E03) passes through a heat exchanger (E04), condenses and is recovered in the alcohol tank (T02) and can be reused in future procedures.

After the distillation step, the mixture is directed by pump (B03) to the second decanter (T03) to perform phase separation by gravity. The heavy fraction, crude glycerin, coming from the stage of phase separation is directed to the glycerin column (C01) by gravity. The light fraction, fatty esters, is pumped in continuous flow passing through the columns of dry polishing (C01 and C02) helped by the vacuum pump and compressed air (B02). The crude biodiesel percolates through the ion exchange resin which retains all the glycerin residues, catalyst and salts of the light fraction (fatty esters), obtaining a high purity biodiesel, which is directed to the biodiesel tank (T04).

All equipment is assembled on a rigid structure, supported by mobile platform with independent wheels. The distribution process flow is performed by flexible polymeric hoses inside the plant and in ¾″ OD tubing in 304 stainless steel in the visible parts. The valves are sphere-type, 304 stainless steel, tripartite, favoring the handling and maintenance of the system.

### Example 1

Receives vegetable oil in natura which is poured into the first reactor (E01) where it is heated to 55° C. and mixed with anhydrous methyl alcohol and sodium methylate 30% in methanol. The mixture is under strong agitation for 60 minutes. Directed by pump (B01) to the first decanter (T01) for phase separation where it remains at rest/in sleep for 40 minutes and from there by gravity, it directs the lower phase to the glycerin tanking (C01) and also the light phase by gravity to the distiller (E03), where the exceeding alcohol is evaporated by heating at 85° C. for 40 minutes with the aid of vacuum (B02). The alcohol which evaporated passes through the heat exchanger (E04) condenses and is then recovered in the alcohol tank (T02). The retained one in the distiller (E03) is pumped (B03) to the second decanter (T03) with the objective of another phase separation, remaining at rest/in sleep for 60 minutes. Again the heavy phase is directed by gravity into the glycerin tank (C01) and the light phase, fatty esters, directed with continuous flow of 8 liters per hour, with the help of vacuum pump and compressed air (B02), to the purification columns (C02 and C03) where the crude biodiesel percolates through ion exchange polymeric resin which retains all the glycerin residues, catalyst and salts. Still in continuous flow, the purified biodiesel will be placed into its storage tank (T04).

### Example 2

Receives vegetable oil in natura which is poured into the first reactor (E01) where it is heated to 65° C. and mixed with anhydrous ethyl alcohol and sodium methylate 30% in methanol. The mixture is under strong agitation for 3 minutes and is directed by pump (B01) to the second reactor (E02) in a continuous flow of 2 liters per minute and, moving straight to the distiller (E03). In this, the exceeding alcohol is evaporated by heating at 95° C. for 40 minutes with the aid of vacuum (B02). The alcohol which evaporated passes through the heat exchanger (E04) condenses and is then recovered in the alcohol tank (T02). The one retained in the distiller (E03) is pumped (B03) to the second decanter (T03) with the objective of phase separation, remaining at rest/in sleep for 60 minutes. The heavy phase is directed by gravity into the glycerin tank (C01) and the light phase, fatty esters, directed with continuous flow of 8 liters per hour, with the help of vacuum pump and compressed air (B02), to the purification columns (C02 and C03) where the crude biodiesel percolates through ion exchange polymeric resin which retains all the glycerin residues, catalyst and salts. Still in continuous flow, the purified biodiesel will be placed into its storage tank (T04).

1. BIODIESEL DIDACTIC PLANT INDUSTRIAL SIMULATION with configuration and arrangement of the constituents organized on a modular rigid structure (MS) and platform on wheels (PM), EP (electric panel): central control for activating the pumps, engines, equipment and compressed air flow system; E01: reactor with stirring and heating (A01) controlled for refining reactions or vegetable oil transesterification; E02: reactor by irradiation by ultra-sound and control system of the reaction parameters; T01: decanter for separation of the phases of the refining or vegetable oil transesterification, built using borosilicate-type glass of high resistance, with 304 stainless steel support flanges and Viton® sealing; T03: Same as T01, operated in series to it; E03, distiller with thermal oil heating system, jacketed, with temperature control and timing set by PLC; E04: heat exchanger (E04) to condense the alcohol vapor produced in E03, T02: alcohol tank “Kitasato flask” in borosilicate-type glass; C01: steering column for store the glycerin which was produced and separated in the process; C02: dry polishing column, in 304 stainless steel tube with windows properly positioned to monitor the purification process and saturation of the resin contained therein; C03: Same as C02, operated in series to it; T04: biodiesel tank constructed in borosilicate-type glass of high resistance, with 304 stainless steel support flanges and Viton® sealing.

2. Making use of the equipment described and arranged according to claim 1, the DIDACTIC PROCESS OF BIODIESEL PRODUCTION, characterized by:
a) performing the reaction in E01 with heating, for use of A01, and forced mechanical agitation;
b) performing the reaction in E02 by irradiation by ultra-sound and control system of the parameters;
c) after enough time elapsed, the reaction mixture is conducted by pumping (B01) from E01 or E02, to E03 or T02;
d) directing the light phase, fatty esters, by gravity to the next stage of distillation;
e) also directing by gravity, the more dense phase, rich in glycerin to C01;
f) evaporation of the exceeding alcohol by heating carried out by E03, as reduction of residues production, recovery of the alcohol and increase in the level of purity of the product biodiesel and co-product glycerin;
g) directing the mixture held in the distiller (E03) by pumping (B03), to phase separation in T03;
h) after enough time elapsed, directing the more dense phase, rich in glycerin, by gravity to C01 and the light phase, fatty esters, to purification stage (C02 and C03);
i) through pumping (B02) in continuous flow percolates the crude biodiesel through ion exchange resin in C02 and C03;
j) directing the purified biodiesel from C03 by pumping (B02) to T04.

3. BIODIESEL DIDACTIC PLANT INDUSTRY SIMULATION, characterized by allowing the operation in university laboratories, biodiesel companies, education and research institutions.

4. According to claims 1, characterized by establishing DIDACTIC PROCESS OF BIODIESEL PRODUCTION, designed and organized in a modular structure on wheels, with transparent tanks enabling monitoring of all the stages of the production process.

5. BIODIESEL PRODUCTION PROCESS FOR INDUSTRIAL SIMULATION systematized according to claims 1 characterized by enabling parameter settings of the industrial processes from the simulation and parameter settings in BIODIESEL DIDACTIC PLANT INDUSTRIAL SIMULATION.

6. Reduction of waste generation, as claims 1, the DIDACTIC PROCESS OF BIODIESEL PRODUCTION characterized by enabling the dry wash of biodiesel through the of ion exchange resin columns C02 and C03.
